(19) United States
(12) Patent Application Publication
(10) Pub. No.: US 2007/0192525 A1
(43) Pub. Date: Aug. 16, 2007

(54) TRANSLATION DEVICE BETWEEN A CLIENT-SERVER NETWORK AND A MASTER-SLAVE GENERAL PURPOSE INSTRUMENT BUS (GPIB) REQUIRING NO DRIVER SOFTWARE, AND METHODS THEREFOR

(76) Inventors: Daniel H Chang, La Crescenta, CA (US); Greg Cardell, La Canada, CA (US)

Correspondence Address: Daniel H. Chang, 3161 Alabama St, La Crescenta, CA, 91214-2704, US

(21) Appl. No.: 11/307,653

(22) Filed: Feb. 15, 2006

(51) Int. Cl. G06F 13/36

(52) U.S. Cl. 710/306

(57) ABSTRACT

A translation device between client-server computer networks and the General Purpose Instrumentation Bus (GPIB). Methods for Write, Read, and Command transactions to conduct data transfer between client-server computer networks and GPIB. Separate data channels and a single control channel are utilized. No specialized driver software is required.

### FIELD OF THE INVENTION

The field of the present invention relates to electronic test and measurement equipment, more particularly the standard General Purpose Instrument Bus (GPIB), still more particularly to devices, software, and methods to translate between GPIB and client/server networks such as TCP/IP.

### BACKGROUND OF THE INVENTION

The General Purpose Instrument Bus (GPIB)—the name by which the data bus and syntax conventions defined in the IEEE Standards 488.1 and 488.2 are collectively known—is ubiquitous as the de-facto means of remotely programming and controlling test and measurement equipment. It is, however, lacking in several respects. GPIB physical connectors and cabling are bulky and expensive—in many ways outdated by today's technological standards. In addition, the bus lends itself poorly to extension, in both physical size and number of devices connected to it. Finally, because GPIB is used almost exclusively in the test and measurement arena, the typical application of a personal computer controlling instruments requires the addition to the computer of specialized hardware and driver software.

On the other hand, the client-server network capability that is ubiquitous in personal computers—most prominently, the TCP/IP network protocol behind the Internet—is highly scalable to large physical and network sizes, accommodates a wide variety of physical layers from thin, cheap twisted-pair cables to wireless links, and is fully supported in virtually all personal computing platforms.

What is desired are devices, and methods therefor, that can serve as a translator between a client-server network and a measurement system comprising devices connected to a GPIB. What is also desired are such translation devices, and methods therefor, that require no specialized software—typically referred to as driver software—to run on the controlling computer platform, thereby maximizing portability of application specific software, and minimizing the amount of new knowledge required to use the devices.

### REFERENCES

IEEE Standard No. 488.1—Standard for Higher Performance Protocol for the Standard Digital Interface for Programmable Instrumentation. IEEE, New York, N.Y., 1978.

IEEE Standard No. 488.2—Standard Digital Interface for Programmable Instrumentation. IEEE, New York, N.Y., 1987.

### SUMMARY OF THE INVENTION

In a first aspect, the invention provides a device that serves as a translator between data on a network-enabled computer and devices on a GPIB bus. A client-server network such as TCP/IP is the preferred embodiment, although others are possible. The invention utilizes a control channel as well as multiple data channels—one mapped to each GPIB device—to conduct data transfers. The preferred embodiment of the channels are TCP or UDP sockets with various port numbers, although other embodiments are possible. Significantly, no specialized software—typically referred to as driver software—is required on the network-enabled computer to operate with the present invention.

In a second aspect, the invention provides methods of conducting bi-directional data transfer between a client-server network such as TCP/IP and a master-slave bus such as GPIB. The method utilizes multiple network channels—one mapped to each device on the GPIB—as well as a single control channel. The preferred embodiment of the channels are TCP or UDP sockets of various port numbers, although other embodiments are possible.

### BRIEF DESCRIPTION OF THE DRAWINGS

A more complete understanding of the present invention and other aspects and advantages thereof will be gained from a consideration of the following description of the example embodiments, read in conjunction with the following drawings provided therein. In those figures, numerals indicate the various features of the invention, and like numerals represent like features throughout both the drawings and the descriptions.

FIG. 1 is a block diagram schematically depicting how the present invention is used in conjunction with the major functional components of a measurement system enabled by it.

FIG. 2 is a software flow-chart depicting a Short-Write Transaction performed with the present invention, wherein a small amount of information is written from the user's computer to a device on the GPIB bus.

FIG. 3 is a software flow-chart depicting a Long-Write Transaction performed with the present invention, wherein a large amount of information is written from the user's computer to a device on the GPIB bus.

FIG. 4 is a software flow-chart depicting a Read Transaction performed with the present invention, wherein information is requested by the user's computer to be read from a device on the GPIB bus.

FIG. 5 is a software flow-chart depicting a Command Transaction performed with the present invention, wherein detailed control of the GPIB bus, as well as configuration of the present invention, is performed by the user's computer.

### DETAILED DESCRIPTION

While the present invention is open to various modifications and alternative constructions, the embodiments shown in the drawings will be described herein in detail. It is to be understood, however, that there is no intention to limit the invention to the particular forms disclosed. On the contrary, it is intended that the invention cover all modifications, equivalences, and alternative constructions falling within the spirit and scope of the invention as expressed in the appended claims.

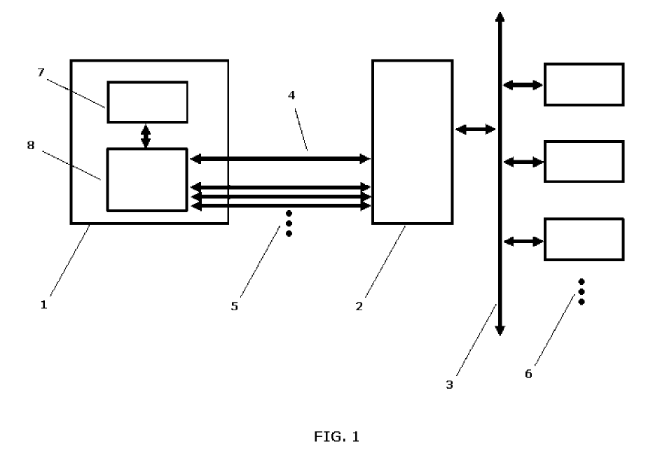

Referring to FIG. 1, a measurement system configured so as to use the present invention includes a user computer 1 on which is running user-specific application software 7 in communication with a network-communication stack 8 (such as TCP/IP), the latter being typically provided as an operating-system service on the user computer 1. The user software 7 defines through the network-stack 8 a single control-socket 4 and a multiplicity of data-sockets 5 to communicate with the translator 2, which contains software of its own, and is equipped to communicate on both the network and the GPIB 3. Connected to the GPIB 3 are a multiplicity of devices 6 to which communication by the user software 7 is effected. There are as many data-sockets 5 as there are devices 6 for which such communication is desired, and a one-to-one mapping between the port number of each data-socket 5 and the GPIB-address of each device 6 is established as a part of the configuration of the translator 2 prior to initial use.

A typical embodiment of the user computer 1 is a personal computer, although any platform which provides a standard network-stack is acceptable. It is noted that no software specific to enabling communication with the translator 2 (typically referred to as “driver” software) is required to be running on the user computer 1.

A typical embodiment of the translator 2 is a microprocessor or microcontroller based circuit, containing embedded software and circuitry to implement the hardware-layer of both the network and GPIB interfaces.

Communications between the user computer 1 and the translator 2 fall into three general categories—Write Transactions, Read Transactions, and Command Transactions. Additionally, Write Transactions are further differentiated as Short-Write and Long-Write Transactions. The translator 2 performs the functions necessary to bridge the difference between the client-server style of communication on the network side and the master-slave style of communication on the GPIB side. As a consequence, each type of transaction is handled differently.

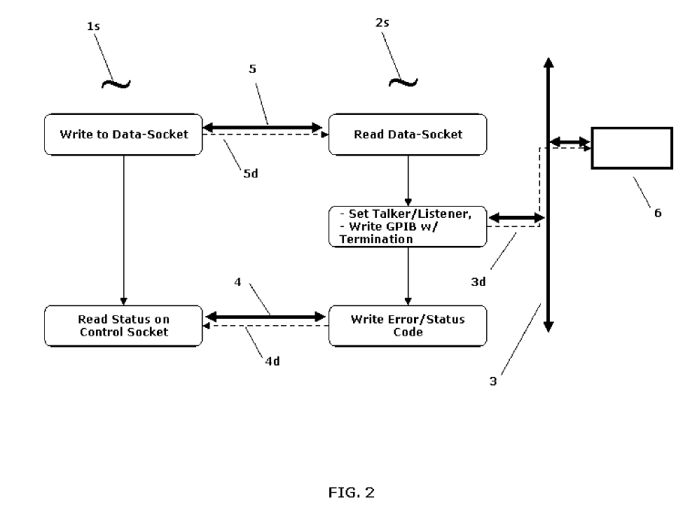

FIG. 2 depicts the software flow for a Short-Write Transaction, in which the intent is for the user software (7 in FIG. 1) to write data to a device 6 on the GPIB bus. In FIG. 2, rounded rectangles refer to software steps, thin solid lines depict software flow, thick solid lines depict physical connections, and thin dashed lines depict data flow across the physical connections. Software 1s running on the user computer (1 in FIG. 1) initiates the transaction by writing data across the data-socket 5 which is uniquely mapped to the target device 6 through initial configuration of the translator (2 in FIG. 1). The amount of data written on the data-socket 5 is less than the memory buffer size allocated in software 2s. A typical range for this buffer size is 128-8192 bytes, although this is simply a matter of3 design. The data transmitted across 5 in Short-Write Transactions are ASCII-encoded data terminated with Line-Feed (ASCII code 10) and/or Carriage-Return (ASCII code 13) characters. The translator software 2s simply reads the data-socket, performs its function as a GPIB Controller-In-Charge by addressing the device 6, and transmits the data (5d and 3d) across the GPIB 3. The translator software 2s strips the termination characters present in data 5d and terminates the GPIB transaction using the method selected as a part of the initial configuration of the translator (2 in FIG. 1). Typically this involves either asserting the EOI line on the GPIB or appending a termination character, as defined in the IEEE-488.1 standard. Finally, the translator software 2s transmits a status message 4d across the control socket 4 to the user software 1s. The status message encodes any errors encountered in the GPIB transmission, or an acknowledgement of transaction-completeness in the event of no errors being present. Alternatively, the translator software 2s does not transmit a status message. Alternatively, the user software 1s does not received a status message.

The Short-Write transaction is so defined because it is a natural implementation of the most likely mode of employment. The most common type of transaction between a user computer and an instrument connected to the GPIB involves a short, ASCII-encoded command sent by the user computer, inducing an action and response from the instrument.

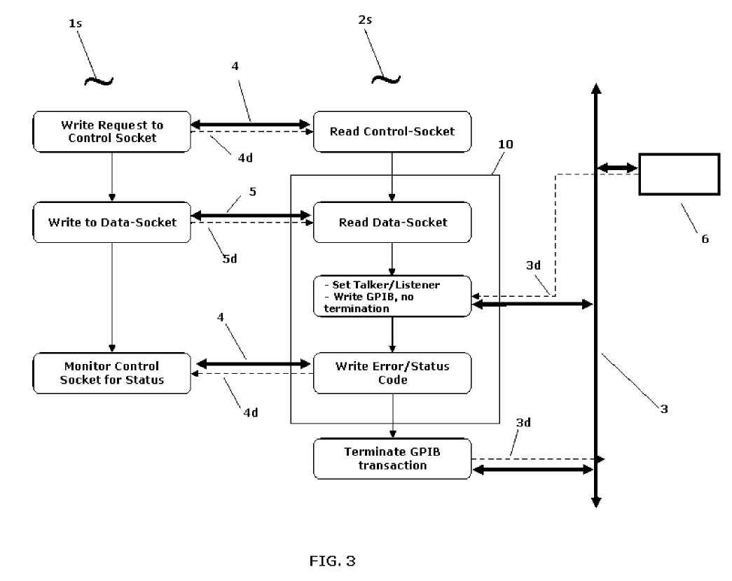

FIG. 3. depicts the software flow for a Long-Write Transaction, in which the intent is for the user software (7 in FIG. 1) to write either a large amount of data and/or binary-encoded data to a device 6 on the GPIB bus. In FIG. 3, rounded rectangles refer to software steps, thin solid lines depict software flow, thick solid lines depict physical connections, and thin dashed lines depict data flow across the physical connections. Software 1s running on the user computer (1 in FIG. 1) initiates the transaction by writing a request command 4d across the control-socket 4. The number of bytes to be transmitted to target device 6 is specified as a field in the command. This number is typically larger than the memory buffer size allocated in software 2s, although it does not have to be. A typical range for this buffer size is 128-8192 bytes, although this is simply a matter of design. Subsequently, the data 5d is sent across the data-socket 5 which is uniquely mapped to device 6 through initial configuration of the translator (2 in FIG. 1). The data transmitted across 5 in Long-Write Transactions are binary-encoded, in contrast to the case in Short-Write Transactions. Because of the binary encoding, the data does not contain any embedded termination characters, hence the number of bytes in data 5d being specified as a part of the command 4d initiating a Long-Write transaction. The translator software 2s reads the data-socket, performs its function as a GPIB Controller-In-Charge by addressing the device 6, and transmits the data 5d and 3d) across the GPIB 3. The translator software 2s transmits a status message 4d across the control socket 4 to the user software 1s. The status message encodes any errors encountered in the GPIB transmission, or an acknowledgement of transaction-completeness in the event of no errors being present. Alternatively, the translator software 2s does not transmit a status message. Alternatively, the user software 1s does not received a status message. Dotted-box 10 denotes parts of 43 the translator software 2s that needs to iterate if the number of bytes in data 5d exceeds the memory buffer size allocated in software 2s. Accordingly, the GPIB-write of data 3d in each iteration of this loop is not terminated. Instead, a final termination is set after all of the data 5d has been transmitted to target device 6, using the method selected as a part of the initial configuration of the translator (2 in FIG. 1). Typically the termination is implemented by either asserting the EOI line on the GPIB or transmitting a termination character, as defined in the IEEE-488.1 standard.

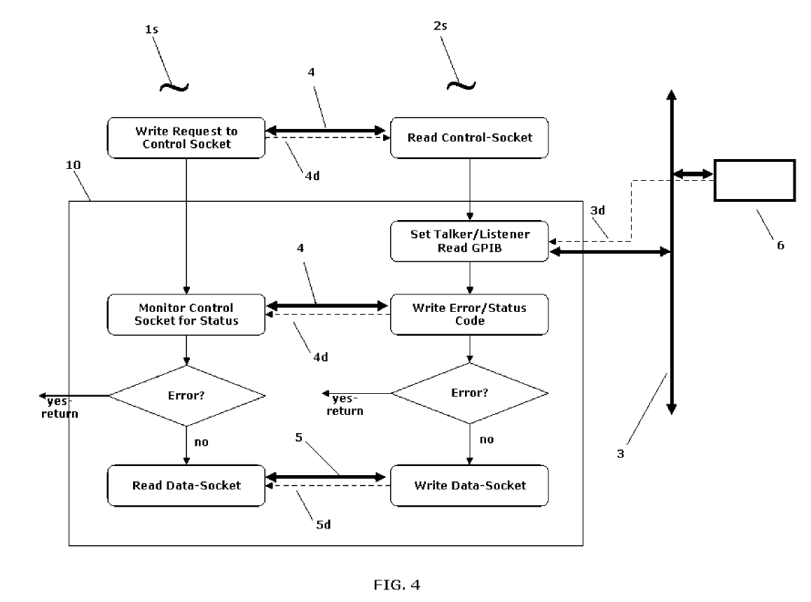

FIG. 4 depicts the software flow for a Read Transaction, in which the intent is for the user software to read data residing on the device 6. In FIG. 4, rounded rectangles refer to software steps, thin solid lines depict software flow, thick solid lines depict physical connections, and thin dashed lines depict data flow across the physical connections. Unlike the case in Short-Write Transactions, the differences between client-server and master-slave style communications are more clearly manifest in Read Transactions. While the data (for example, a measured voltage) exists in (typically) an output queue on the device 6, as a slave it awaits permission from the GPIB Controller-In-Charge to transmit the data. Were the device 6 a part of a client-server network instead, it would take the initiative to transmit the data as it becomes available. Instead, as depicted in FIG. 4, the request to read the data from the device is initiated by the software 1s running the user computer by sending a request 4d across the control-socket 4. Relaying the request to read is the primary purpose of the control-socket; in defining it, the need to transmit read requests “in-band” within the multiplicity of data sockets 5 is avoided. Because a single control-socket is present for the multiplicity of devices 6, the GPIB address of the device to be read is incorporated in the request, along with an expected number of bytes to be read. Software 2s running on the translator received this request on the control-socket and reads the data 3d from device 6 across the GPIB 3 accordingly. The translator software 2s transmits a status message 4d across the control socket 4 to the user software 1s. The status message encodes any errors encountered in the GPIB-read, or an acknowledgement of the transaction in the event of no errors being present. Alternatively, the translator software 2s does not transmit a status message. Alternatively, the user software 1s does not received a status message. If no error occurs, the data 3d is transmitted across the data-socket 5 that is uniquely mapped to the device 6 and is received by the user software 1s, completing the Read Transaction.

The dotted-box 10 in FIG. 4 indicates parts of the software that may iterate for multiple loops in the event of a large data transfer from device 6. An example situation might be the downloading of a large trace-data set from a digital oscilloscope. If the volume of data is larger than the memory buffer size allocated in software 2s, multiple GPIB-reads and data-socket transfers may take place as part of the same Read Transaction. A typical range for this buffer size is 128-8192 bytes, although this is simply a matter of design.

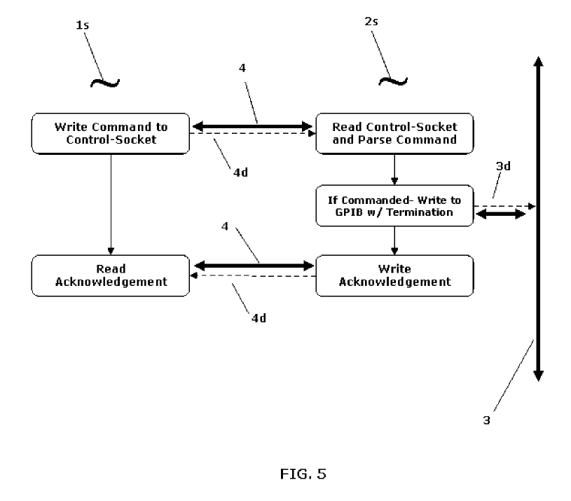

While the primary purpose of the control-socket is for handling Read Transaction requests, it can be also be used for configuration of the translator, as well as low-level GPIB commands. FIG. 5 depicts how these Command Transactions are handled. In FIG. 5, rounded rectangles refer to software steps, thin solid lines depict software flow, thick solid lines depict physical connections, and thin dashed lines depict data flow across the physical connections. A command sent by user software 1s across the control socket 4 is read and parsed by the software 2s in the translator. If appropriate, the GPIB 3 is commanded with appropriate signals 3d. In any case, an acknowledgement is passed back to the user software 1s across the control socket.

Commands that are handled in the manner depicted in FIG. 5 include, but are not necessarily limited to: all “Multi-Line Interface Messages” defined in IEEE Standard 488.1 (DCL, GET, GTL, LLO, MLA, MSA, MTA, PPC, PPD, PPE, PPU, SDC, SPD, SPE, TCT, UNL, UNT); commands to configure the GPIB termination mode and characters, commands to change the data-socket port number to device GPIB-address mapping, commands to manipulate the GPIB REN and IFC lines directly, commands to change transaction timeout values, commands to examine the values of all 8 GPIB control lines, commands to conduct serial and parallel polls as defined by both IEEE Standard 488.1 and 488.2, and commands to establish the existence of listeners at specific addresses on the GPIB.

An alternative embodiment to the Short Write, Long Write, Read, and Command transactions defined herein exists, although it is not the preferred embodiment. The contents transmitted across the control channel in each case can instead be embedded into the data channel for each device, the control-content being delineated either with special characters (often referred to as “escape-sequences”), or through the transmission of special data of pre-agreed upon structure and size (often referred to as “headers”).

What is claimed is:

1. A conversion device between a client-server network and the General Purpose Instrumentation Bus (GPIB), comprising:
a. one or more interfaces to the network
b. one or more interfaces to the GPIB
c. software to perform transactions initiated by a computer connected to the network such that data is written from that computer to devices connected to the GPIB, utilizing a multiplicity of network data channels wherein each channel is uniquely mapped to a device connected to the GPIB
d. software to perform transactions initiated by a computer connected to the network such that data is written from that computer to devices connected to the GPIB, utilizing a network control channel to initiate and control the transactions, and a multiplicity of network data channels wherein each channel is uniquely mapped to a device connected to the GPIB
e. software to perform transactions initiated by a computer connected to the network such that data is read from devices connected to the GPIB and transferred to the computer, utilizing a network control channel to initiate and control the transactions, and a multiplicity of network data channels wherein each channel is uniquely mapped to a device connected to the GPIB.

2. The device of claim 1, wherein the control channel is also utilized to pass commands to the conversion device from a computer connected to the network, for the purpose of configuring the device, as well as for the purpose of directly manipulating the GPIB itself through commands defined in the IEEE Standards 488.1 and 488.2.

3. The device of claims 1, wherein the data and control channels are TCP sockets of different port numbers.

4. The device of claims 1, wherein the data and control channels are UDP sockets of different port numbers.

5. The device of claim 2, wherein the commands comprise the Interface Messages defined in IEEE Standard 488.1: DCL, GET, GTL, IFC, LLO, MLA, MTA, MSA, PPC, PPE, PPD, PPR1-8, PPU, REN, SDC, SPD, SPE, UNL, UNT.

6. The device of claim 2, wherein the commands further comprise those for: configuration of GPIB termination mode and termination character, mapping of network data channels to GPIB device addresses changing transaction timeout values, establishing existence of device connected to the GPIB, collecting and transferring values of the GPIB control lines, and conducting Parallel and Serial Polls as defined in IEEE Standards 488.1 and 488.2.

7. A method of utilizing a client-server network to transfer data residing on devices connected to a General Purpose Instrumentation Bus (GPIB) to a computer connected to the network, the method comprising:
a. defining a control channel on the network
b. defining a multiplicity of data channels on the network, each data channel uniquely mapped to a device connected to the GPIB
c. communicating on the control channel the desire to initiate a data transfer, as well as parameters defining the transfer, the parameters specifying at least the address of the device connected to the GPIB to which communication is desired
d. reading the data residing on the device connected to the GPIB and transferring that data to the computer using the data channel corresponding to that device.

8. A method of utilizing a client-server network to transfer data residing on a computer connected to the network to devices connected to a General Purpose Instrumentation Bus (GPIB), the method comprising:
a. defining a control channel on the network
b. defining a multiplicity of data channels on the network, each data channel uniquely mapped to a device connected to the GPIB
c. in one mode of employment, writing to a data channel corresponding to a device connected to the GPIB to which communication is desired, this write-transaction to the data channel being sufficient to define the corresponding write transaction to the GPIB, then performing said corresponding write transaction to the GPIB
d. in another mode of employment, communicating on the control channel the desire to initiate a data transfer, as well as parameters defining the transfer, the parameters specifying at least the address of the device connected to the GPIB to which communication is desired and the number of bytes to be transmitted, then reading from the data channel said number of bytes, then writing said number of bytes to the device across the GPIB.

9. The method of claim 7, in which a status message acknowledging the transaction, as well as notifying of any errors encountered, is transmitted to the computer following a GPIB-read.

10. The method of claim 8, in which status message acknowledging the transaction, as well as notifying of any errors encountered, is transmitted to the computer following a GPIB-write.

11. The method of claim 7, in which the no control channel is defined, the commands and status being transmitted on the control channel being instead embedded into the data stream in each data channel.

12. The method of claim 8, in which the no control channel is defined, the commands and status being transmitted on the control channel being instead embedded into the data stream in each data channel.
